(19) United States
(12) Patent Application Publication
(10) Pub. No.: US 2024/0272081 A1
(43) Pub. Date: Aug. 15, 2024

(54) ELECTRONIC DEVICE FOR ANALYZING AN ANALYTE PRESENT IN A FLUID COMPRISING A SENSOR AND METHOD OF REPLACING THE SENSOR

(71) Applicant: ARYBALLE, GRENOBLE (FR)

(72) Inventors: Thierry CHAVIGNER, GRENOBLE (FR); Vincent PADIOLLEAU, GRENOBLE (FR)

(21) Appl. No.: 18/290,340

(22) PCT Filed: Mar. 29, 2022
(86) PCT No.: PCT/FR2022/050586

§ 371 Date: Nov. 13, 2023

(30) Foreign Application Priority Data
May 11, 2021 (FR) FR2104992

(51) Int. Cl. G01N 21/77

(52) U.S. Cl. CPC G01N 21/7703; G01N 2021/7763; G01N 2021/7779; G01N 2201/0245

(57) ABSTRACT

The invention relates to an electronic device (1) for analyzing an analyte (2) present in a fluid, comprising:
a sensor (10) comprising a photonic chip (12) comprising a light guide (13) in which receptors (14) are arranged capable of interacting with the analyte present in the fluid, the interaction causing a local property change, and
a sensor support (50);
a closing element (60);
a local property change transducer capable of converting the local property change into an electronic signal expressing the local property change, this transducer comprising:
a light source (130);
an optical detector (131),
   the light guide comprising an interference arm (134) into which a resulting light beam is guided, characterized in that the radiant power of the resulting light beam guided into the interference arm is equal to or greater than 0.2 μW.

### TECHNICAL FIELD

The field of the invention is that of measurement and physical analysis techniques, particularly electronic measurement and physical analysis techniques. More specifically, the present invention refers to an electronic device for analyzing an analyte present in a fluid, the electronic analysis device presenting a sensor. The present invention also refers to a method of replacing the sensor.

### PRIOR ART

Electronic analysis devices enabling the presence of an analyte in a fluid such as a gas or a liquid to be detected, the analyte to be identified, and possibly the concentration of the analyte in the fluid to be measured are known. The analyte may be a combination of target compounds, for example a mixture of VOC (volatile organic compounds) that can produce an odor. This is why these devices are sometimes classified as electronic noses or tongues, according to whether they function for gases or liquids.

The principle of detection in these devices may be based on interactions between receptors integrated into a sensor and the analyte. The interactions are based on the properties of physical-chemical affinity between the receptors and the analyte, particularly between the receptors and the target compounds of the analyte. These interactions lead to a change in one or more local properties, revealing the presence of the analyte, or even the quantity of analyte present.

The receptors may be chosen from among various compounds or materials suitable for constituting a temporary ligand for the target compounds. The following may be cited, but are not limited to: specific molecules, peptides, polymers, biomarkers, nanoparticles, carbon nanotubes. The bonding forces at issue are generally weak forces (Van Der Waals type forces).

A transducer is generally used to convert this local property change into a multidimensional electronic signal representative of this local property change. An electronic signal is generated for each receptor. The set of electronic signals constitutes the multidimensional electronic signal. By means of processing and analysis of this multidimensional electronic signal, it is then possible to make a qualitative, or even quantitative determination of the analyte present in the analyzed fluid.

Some electronic analysis devices enable the local property change to be detected by using light interference. The electronic analysis device thus comprises a sensor comprising a photonic chip with a light guide and a transducer comprising a source of coherent light to emit a coherent light beam into the light guide, and an optical detector to measure at least one optical parameter of the light beam, at the outlet of the light guide.

The light guide is shaped to enable the formation of light interference, and the receptors are integrated into the light guide. The local property change generated by the interaction between the analyte and the receptors in the light guide creates light interference. This light interference thus depends on the interactions between the analyte and the receptors, and is therefore specific to the analyzed analyte.

The created light interference modifies the optical parameter measured by the optical detector. Thus, from the optical parameter measured by the optical detector, the transducer can generate an electronic signal expressing the local property change, and thus reveal the analyte.

In order for the optical detector to measure the optical parameter of the light beam correctly, the light source and the light guide must be aligned. This alignment makes it possible for the amount of light entering the light guide to be sufficient for the optical detector to detect the optical parameter of the light beam at the outlet of the light guide, and therefore for the electronic signal generated by the transducer to express the local property change, and for the transducer to enable the presence of the analyte to be detected. The alignment between the light source and the light guide is therefore very important for the qualitative or even quantitative determination of the analyte present in the analyzed fluid.

However, the receptors used to interact with the analyte are temporary receptors, i.e. they have a lifetime that is more limited than the other components of the device. In fact, the interaction between the receptors and the analyte may lead to saturation of the receptors. When the receptors are saturated, they can no longer correctly interact with the analyte of the fluid. The sensor integrating the receptors must then be replaced.

The receptors may also be specific to a type of analyte that one wishes to detect. In fact, the receptors may present a particular affinity with a given type of analyte. Therefore, if one wishes to change the type of analyte to be detected, it may become necessary to replace the sensor with another sensor with receptors that are suitable for detecting the new type of analyte that one wishes to detect.

It is therefore understood that to limit costs, replacing the sensor in the device rather than having to change the entire device is preferable, when the temporary receptors no longer function or when one wishes to detect another analyte.

When the sensor is replaced, one must ensure that the light guide of the new sensor is aligned with the light source of the device. For the user who replaces the sensor, ensuring the proper alignment of the light source and the light guide inlet is long and tedious.

US20120214707A1 is a patent application that discloses a method and a measurement system for detecting an analyte in a sample SAM of fluid (vapor, gas § [0002]). This system comprises an interferometric sensor, in which the light beam originating from a laser LSO is coupled to an optical (channel) waveguide structure WGS. The waveguide structure WGS is constituted of three layers, i.e. the substrate SUB, the core layer COR and the cover layer COV (FIGS. 1A & 1B). The (bio-)sensor device comprises a (portable) measurement system POD and a Lab-On-Chip (LOC) system. The LOC comprises an inlet INL, a supply of fluid ((micro-)fluidic cuvette FCV), a detecting part SRG comprising measurement (pre-coated with receptors REC) and reference regions and an outlet OTL to discharge the fluid or the air or another gas after feeding the sample into the detecting part. The system may be interchangeable. The fluid connection with the LOC system may be arranged to allow fast interchangeability, for example it may be configured as a modular unit that can be quickly positioned during insertion of the LOC system into the POD system. This system may be preferable in combination with an auto-alignment method to enable a faster and better coupling of the (laser) light beam into the optical waveguide chip, after insertion of the LOC system into the POD system. In addition, the receptor REC layers used to pre-coat the chip may be better preserved in such an integrated and closed system. Such a closed system may protect the receptors, such as antibodies, from (rapid) deterioration and may also prevent contamination of detecting regions/windows after the pre-coating process and before the application of analyte samples. This closed system for protecting receptors REC is formed by the POD. A detector, for example a CCD camera, which is included in the POD (and not on the POD) enables the optical measurement signals, originating from the interferometric sensor, to be read.

EP2327955A1 describes an optical detection system for labelling-free high-sensitivity bioassays comprising an optical measurement system (100) and an element (200) for receiving a fluid having multiple analytes, said element comprising a plurality of biosensitive cells (201). The optical measurement system (100) comprises at least one excitation source (101), an optical head (103, 103a, 103b), arranged to analyze each of said biosensitive cells and the analytes that they contain, and optical means for detecting (102) a signal originating from the optical head (103, 103a, 103b). Each biosensitive cell comprises: a substrate (55), a plurality of resonant cavities (53), each cavity being defined by one of said micropillars, the base of which rests on the substrate such that the space between the micropillars receives the fluid to be analyzed, a plurality of Bragg reflectors, at least two per resonant cavity (53), situated respectively at each end of the micropillar, and a plurality of molecular receptors (54) attached to the lateral surfaces of the micropillars so as to be in contact with the fluid. This labelling-free bio-detection system is intended to be competitive in terms of industrial commercialization, sensitivity, measuring cadence, robustness and cost, by combining several detection methods (“by combining the interferometric and resonant advantages of novel photonic structures with optical interrogation techniques such as spectrometry, ellipsometry as well [ . . . ] interrogation process” in paragraph [0001] of D2), including vertical optical interrogation techniques in particular.

An object of the invention is thus to provide a compact and integrated electronic analysis device, in which the sensor is consumable and interchangeable, and in which the alignment between the light source and the light guide inlet is not left to the user who replaces the sensor.

Another object of the invention is to provide a compact and integrated electronic analysis device that minimizes, or even prevents, an erroneous qualitative or even quantitative determination of an analyte present in an analyzed fluid.

Another object of the invention is to provide a compact and integrated electronic analysis device in which the detection by the detector of a local property change generated by the interaction between the receptors and the analyte is guaranteed, so that the electronic signal generated by the transducer corresponds to the actual interaction between the receptors and the analyte.

Another object of the invention is to guarantee that the optical parameter of the light beam measured by the optical detector can reveal the local property change.

### SUMMARY

The present invention aims to address the need mentioned above.

To that effect, the invention, according to a first aspect, provides an electronic device for analyzing an analyte present in a fluid, characterized in that it comprises:
a consumable and interchangeable sensor comprising
i) a photonic chip comprising at least one measurement chamber comprising a light guide in which temporary receptors capable of interacting with the analyte present in the fluid are arranged, the interaction causing a local property change, the light guide comprising a light inlet and a light outlet, and
ii) a cap integral with the photonic chip and comprising an opening suitable for admitting fluid into the measurement chamber and for discharging fluid from the measurement chamber;
a sensor support comprising a housing in which the sensor is intended to be placed in a reversible manner;
a closing element cooperating with the sensor support to encapsulate the sensor;
a local property change transducer, the change being caused by the interaction between the receptors and the analyte, capable of converting the local property change into an electronic signal expressing the local property change, this transducer comprising:
a coherent light source, on the one hand, capable of emitting a coherent light beam into the light guide of the photonic chip, and, on the other hand, positioned on the cap of the sensor or on the closing element;
an optical detector arranged facing the light outlet of the light guide and capable of measuring an optical parameter of the light beam according to the local property change, at the outlet of the light guide.

The sensor is consumable and is reversibly placed. Therefore, the sensor may be changed without having to change all the other components of the device.

In addition, thanks to the positioning of the light source on the cap of the sensor or on the closing element, the user replacing the sensor does not have to deal with aligning the light source with the inlet of the light guide when replacing the sensor.

In fact, when the light source is positioned on the cap of the sensor, during replacement of the sensor, the light source is removed with the sensor and a new light source positioned on the cap of the new sensor is then introduced into the device when the new sensor is integrated into the housing of the sensor support. Thus, the alignment between the light source and the light inlet of the light guide is the responsibility of the sensor manufacturer, which positions the light source on the cap.

Consequently, according to a first embodiment of the invention, in which the light source is positioned on the cap of the sensor, the alignment between the light source and the light inlet of the light guide is performed when the device according to the invention is manufactured.

In addition, according to a 2nd embodiment of the invention, in which the light source is positioned on the closing element, the alignment between the light source and the inlet of the light guide is achieved by the placement of the sensor into the support housing and by the cooperation between the closing element and the support, at the moment the sensor is encapsulated. Thus, when the sensor is replaced, the light source remains on the closing element, and the alignment between the light source and the light inlet of the light guide is guaranteed by the indexing, designed by the manufacturer, of the closing element in relation to the sensor support.

According to a variation, the light guide comprises at least one branch comprising a reference arm in which a part of the light beam emitted by the light source is intended to be guided by total internal reflection, and a measurement arm in which another part of the light beam emitted by the light source is intended to be guided by total internal reflection and in which the receptors are arranged, the reference arm and the measurement arm being recombined into an interference arm into which a resulting light beam which results from recombining the part of the light beam guided into the reference arm and the other part of the light beam guided into the measurement arm is intended to be guided, and

the radiant power of the resulting light beam guided into the interference arm is equal to or greater than 0.2 μW.

Imposing a minimum power of the resulting light beam at 0.2 μW ensures that a sufficient quantity of light passes into the light guide, so that the detector can measure the optical parameter of the light beam at the outlet of the light guide.

In addition, this minimum power of the resulting light beam guarantees that, when the optical parameter of the light beam is modified due to the local property change, this modification can be measured by the optical detector. In particular, the optical detector is thus sensitive to the variation in value of the optical parameter caused by the local property change, and thus by the presence of the analyte. Therefore, the electronic signal generated by the transducer clearly expresses the local property change. The qualitative or even quantitative determination of the analyte present in the analyzed fluid is carried out correctly.

According to a variation, the electronic analysis device comprises a plurality of branches, each branch comprising a reference arm and a measurement arm that recombine into an interference arm. For example, the electronic analysis device comprises 64 branches. The detection accuracy of the analyte determination is then improved since the resulting light beam of each branch is measured. Each branch provides its own detection, and the light beam measured by the optical detector at the outlet of the guide is impacted by each branch.

According to a variation, the interference arm of each branch has a first end connected to the reference arm and to the measurement arm, and a second end through which the resulting light beam is intended to be issued. The second end thus forms the light outlet of the light guide. When the light guide comprises several branches, the light outlet of the light guide is formed by the second end of each interference arm. Thus, the light beam at the outlet of the light guide is formed by all of the resulting light beams guided into the interference arms.

According to a variation, the interference arm of each branch is divided, at its second end, into three sub-arms, the resulting light beam being separated and guided into each of these three sub-arms and the three sub-arms being configured to shift the phase of the resulting light beam by 120° between each of the sub-arms. In other words, the interference arm is divided into a first sub-arm receiving a first part of the resulting light beam and configured to shift the phase of the first part of the resulting light beam by 0° in relation to the resulting light beam, i.e. to not shift the phase of the first part of the resulting light beam, a second sub-arm receiving a second part of the resulting light beam and configured to shift the phase of the second part of the resulting light beam by 120° in relation to the resulting light beam, and a third sub-arm receiving a third part of the resulting light beam and configured to shift the phase of the third part of the resulting light beam by 240° in relation to the resulting light beam.

The light outlet of the light guide is then formed by all three sub-arms. The radiant power of the resulting light beam thus corresponds to the sum of the radiant powers at the outlet of each of the three sub-arms, i.e. the sum of the radiant powers from the first part of the resulting light beam, from the second part of the resulting light beam, and from the third part of the resulting light beam.

When the light guide comprises several branches, the light outlet of the light guide is formed by all three sub-arms of each interference arm. Thus, the light beam at the outlet of the light guide is formed by all of the parts of the resulting light beams guided into the sub-arms of each interference arm.

According to a variation, the cap comprises an upper surface arranged facing the closing element, and the light beam emitted by the light source has an emission axis substantially parallel to the upper surface of the cap.

The perpendicular incidence of the light beam at the upper surface of the cap facilitates the integration of the light source to the electronic analysis device, particularly when the light source is positioned on the cap. In addition, this facilitates the alignment between the light source and the inlet of the light guide. Thus, the manufacturing costs of the electronic analysis device are reduced.

According to a variation, the receptors of the measurement chamber are selected from among molecules, peptides, polymers, biomarkers, nanoparticles or carbon nanotubes.

According to a variation, the analyte is a combination of target compounds, for example volatile organic compounds, contained in the fluid, preferably the analyte is a mixture of volatile organic compounds characteristic of an odor contained in the fluid.

According to a variation, the optical detector is positioned on the closing element.

The connecting of the electrical power supply of the optical detector is thus facilitated.

According to a first alternative, the light source is positioned on the cap of the sensor, and the electronic analysis device comprises
electronic traces etched on the cap on which the light source is arranged,
an electronic circuit on the closing element, and
an electric contactor enabling the electronic traces to be connected to the electronic circuit in order to supply power to the light source.

The light source may thus easily be supplied with power via the electronic circuit and the electronic traces.

For example, the electric connector is a Pogo® pin.

According to a second alternative, the light source is positioned on the closing element, and the electronic analysis device comprises an optical system that preferably comprises at least one lens, which is intended to collimate the light beam.

The angle of incidence of the light beam at the inlet of the light guide is therefore better controlled.

According to a variation, the sensor comprises protection for the temporary receptors which is configured to be active before the sensor is placed into the housing of the sensor support and to be deactivated by the placement of the sensor into the housing of the sensor support.

The temporary receptors that form the sensitive part of the device are thus protected by the protection. The temporary receptors are thus isolated from the external atmosphere before the sensor is placed into the sensor support, and are not altered before being used in the device. This protection is positioned just after manufacturing, and is therefore in place during storage of the sensor and until the sensor is integrated into the electronic analysis device, where the temporary receptors are no longer subject to a risk of exogenous pollution. Protection of the temporary receptors is obtained without detriment to the ease of placement and removal of the sensor into and from the device, or to the quality of the analysis.

Moreover, when the sensor is placed into the housing of the sensor support, the cooperation between the temporary receptor protection and the sensor support enables the protection of the temporary receptors to be deactivated. Fluid can thus circulate in the measurement chamber of the sensor, and can reach the temporary receptors. Thus, deactivation of the protection guarantees an optimal use of the sensor and of the temporary receptors.

According to a variation, the temporary receptor protection comprises a protective envelope configured to:
close off the cap opening before the sensor is placed into the housing of the sensor support, and
cooperate with the closing element so as to be pierced facing the cap opening when the sensor is placed into the housing of the sensor support.

According to a variation, the closing element comprises a peripheral wall that reversibly fits together with the sensor support.

This arrangement between the peripheral wall and the sensor support optimizes the alignment between the closing element and the sensor support. When the light source is positioned on the closing element, the fit between the peripheral wall of the closing element and the sensor support guarantees the alignment between the light source and the inlet of the light guide.

According to a variation, the closing element comprises a connection in fluid communication with the cap opening to enable the admission and discharge of fluid into and from the measurement chamber.

The fluid may thus be admitted by the closing element, through the connection.

According to a variation, the cap opening comprises an intake opening configured to admit fluid into the measurement chamber and a discharge opening configured to discharge fluid from the measurement chamber.

The fluid to be analyzed may thus circulate between the intake opening and the discharge opening during measurement.

According to a variation, the connection of the closing element comprises a fluid intake conduit in fluid communication with the intake opening of the cap and a fluid discharge conduit in fluid communication with the discharge opening of the cap.

According to a variation, the intake conduit, respectively the discharge conduit, comprises a base with a contact surface arranged facing the intake opening, respectively the discharge opening, which extends on both sides of the intake opening, respectively of the discharge opening, in order to guarantee leaktightness of the measurement chamber.

The base ensures good contact between the intake conduit, the discharge conduit and the measurement chamber in order to guarantee leaktightness between the intake and discharge conduits and the cap of the sensor. In addition, it facilitates the alignment between the intake conduit and the intake opening on the one hand, and the discharge conduit and the discharge opening on the other hand.

According to a variation, the local property change is an optical index change in the sensor.

According to a variation, the optical parameter is the light intensity or the radiant power.

According to a second aspect, the invention provides a method of replacing a sensor of an electronic analysis device according to the first aspect of the invention, wherein
the sensor is removed from the housing of the sensor support,
a new sensor is positioned into the housing of the sensor support.

### BRIEF DESCRIPTION OF THE DRAWINGS

Other features, details and advantages will appear upon reading the detailed description below, and analyzing the attached drawings, in which:

FIG. 1

FIG. 1 represents an electronic analysis device according to a first embodiment of the invention comprising a sensor, a sensor support, a closing element, and a transducer.

FIG. 2

FIG. 2 represents a cross-sectional view of the electronic analysis device from FIG. 1 along a longitudinal plane.

FIG. 3

FIG. 3 represents a top view of a photonic chip of the sensor of the electronic analysis device represented in FIG. 1, comprising a measurement chamber comprising a light guide.

FIG. 4

FIG. 4 shows an enlarged view of the zone referenced IV in FIG. 3 representing a part of the light guide situated near the light inlet of the light guide.

FIG. 5

FIG. 5 shows an enlarged view of the zone referenced V in FIG. 4 representing a branch of the light guide with a reference arm and a measurement arm.

FIG. 6

FIG. 6 schematically illustrates a branch of the light guide with a reference arm and a measurement arm in which the receptors are integrated.

FIG. 7

FIG. 7 schematically illustrates the reaction between the receptors and an analyte to be analyzed.

FIG. 8

FIG. 8 shows an enlarged view of the zone referenced VIII in FIG. 3 representing a part of the light outlet of the light guide.

FIG. 9

FIG. 9 represents a schematic cross-sectional view of the electronic analysis device from FIG. 1 configured according to the first embodiment, along a longitudinal plane, in which the light source of the transducer is positioned on the cap of the sensor.

FIG. 10

FIG. 10 represents an enlarged view of the zone referenced X in FIG. 9, comprising the light source.

FIG. 11

FIG. 11 represents a schematic cross-sectional view similar to that of FIG. 9 of an electronic analysis device configured according to a second embodiment, in which the light source of the transducer is positioned on the closing element.

FIG. 12

FIG. 12 represents an image formed by the optical detector of the transducer.

FIG. 13

FIG. 13 represents a graph showing electrical signals formed by the transducer.

FIG. 14

FIG. 14 illustrates the 3rd calibration method according to the invention, on an image formed by the optical detector of the transducer.

FIG. 15

FIG. 15 illustrates a variation of the 3rd calibration method according to the invention, on an image formed by the optical detector of the transducer.

FIG. 16

FIG. 16 represents an image formed by the optical detector of the transducer, not calibrated according to the 1^{st}, 2^{nd} and 3^{rd} calibration methods according to the invention.

FIG. 17

FIG. 17 represents an image formed by the optical detector of the transducer, calibrated according to the 1^{st}, 2^{nd} and 3^{rd} calibration methods according to the invention.

FIG. 18

FIG. 18 represents a schematic cross-sectional view similar to that of FIG. 9 or 11 of an electronic analysis device configured according to a variation embodiment, in which the cap defining the measurement chamber is arranged below the photonic chip.

### DESCRIPTION OF EMBODIMENTS

In the figures, the same references designate identical or similar elements.

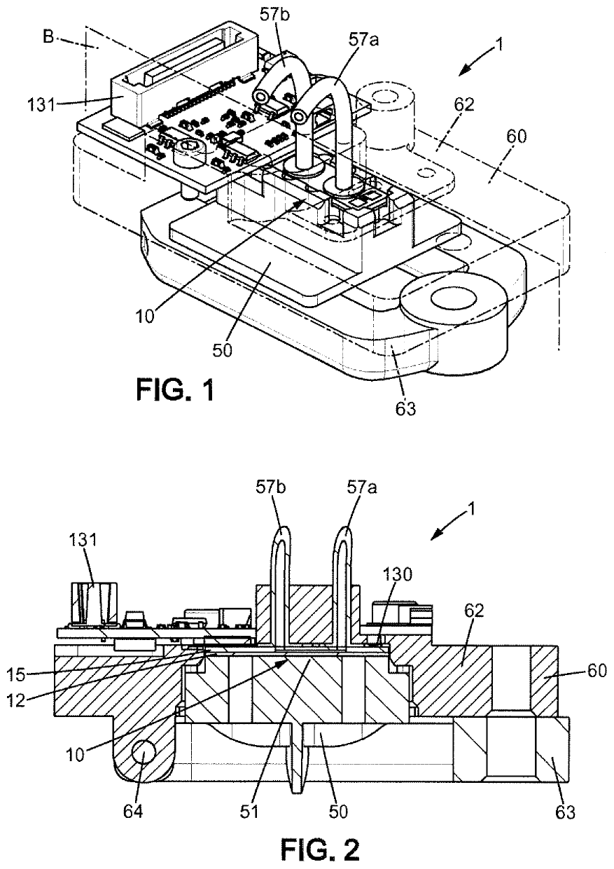

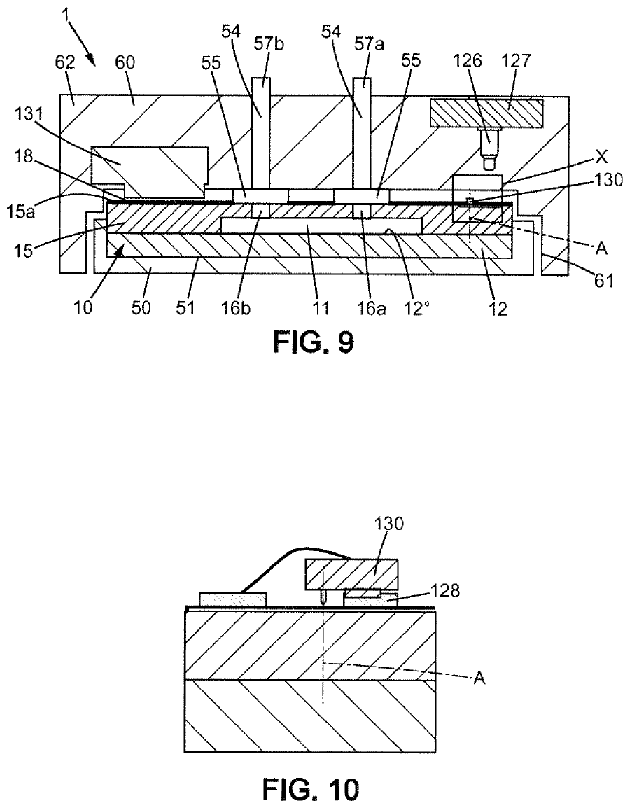

FIG. 1 represents an electronic analysis device 1 according to a first embodiment of the invention. A cross-sectional view along a longitudinal plane B illustrated in FIG. 1 of the electronic analysis device 1 is also represented in FIG. 2, and a schematic cross-sectional view along the longitudinal plane B illustrated in FIG. 1 of the electronic analysis device 1 is also represented in FIG. 9.

Electronic analysis device 1 comprises a consumable and interchangeable sensor 10, and allows analyzing an analyte 2 for which its presence in a fluid to be analyzed is demonstrated by sensor 10. Electronic analysis device 1 thus makes it possible to detect the presence of analyte 2 in the fluid to be analyzed, or even to determine the quantity of analyte 2 in the fluid to be analyzed.

The fluid may be a gas or a liquid. Analyte 2 may be a combination of target compounds, for example volatile organic compounds contained in the fluid. In particular, analyte 2 may be a mixture of volatile organic compounds characteristic of an odor contained in the fluid.

Electronic analysis device 1 also comprises a sensor support 50 comprising a housing 51 in which sensor 10 is reversibly placed, and a closing element 60. In particular, sensor support 50 comprises a recess forming housing 51. Closing element 60 cooperates with sensor support 50 to encapsulate sensor 10. Sensor 10 is thus protected by sensor support 50 and closing element 60.

In the example represented, closing element 60 is formed by an upper part 62 arranged facing sensor 10 and a lower part arranged facing sensor support 50. Upper part 62 and lower part 63 are connected by a hinge 64. Closing element 60 thus enables sensor 10 to be protected. Alternatively, closing element 60 could be formed by upper part 62 only.

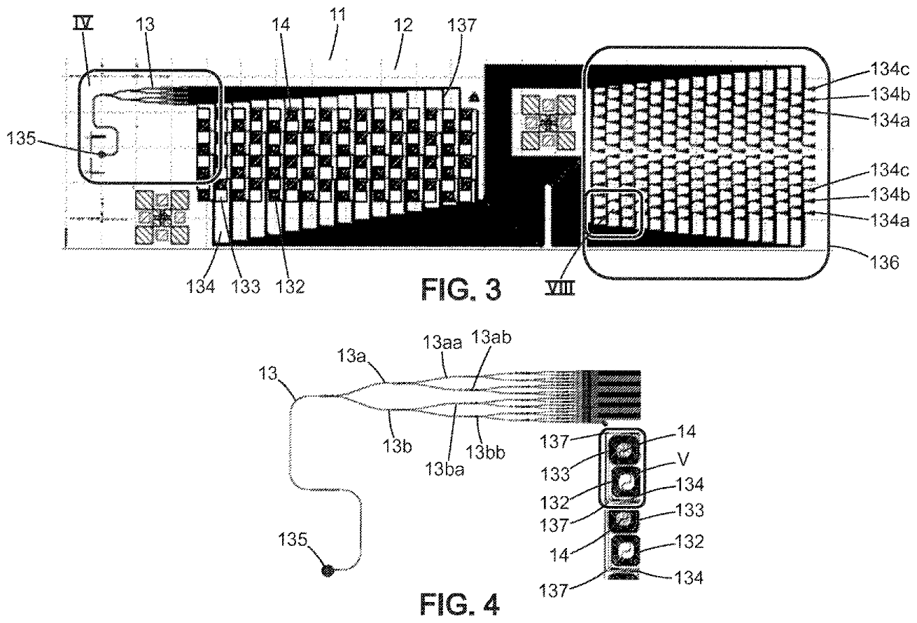

Sensor 10 comprises a photonic chip 12 visible in FIGS. 2 and 9, a top view of which is represented in FIG. 3. Photonic chip 12 comprises a measurement chamber 11 making it possible to demonstrate the presence of analyte 2 in the fluid to be analyzed. A light guide 13, in which receptors 14 are arranged, is positioned in measurement chamber 11, on the surface 12° of photonic chip 12, facing measurement chamber 11. This surface 12° thus made functionally active by receptors 14 may interact with analyte 2 present in the fluid to be analyzed. The interaction between receptors 14 and analyte 2 causes a local property change. Thus, when receptors 14 are in the presence of analyte 2, at least one local property characteristic of the medium in which receptors 14 are positioned is modified. In the example illustrated, the local property is the optical index of the medium.

Receptors 14 may be selected from among molecules, peptides, polymers, biomarkers, nanoparticles or carbon nanotubes. Receptors 14 are temporary receptors. They have a more limited lifetime than other components of the electronic analysis device 1. In fact, receptors 14 may be saturated by the interaction between receptors 14 and analyte 2. In addition, they are specific to the detection of a type of analyte and must be changed when the analyte to be detected changes.

Light guide 13 comprises a light inlet 135 and a light outlet 136.

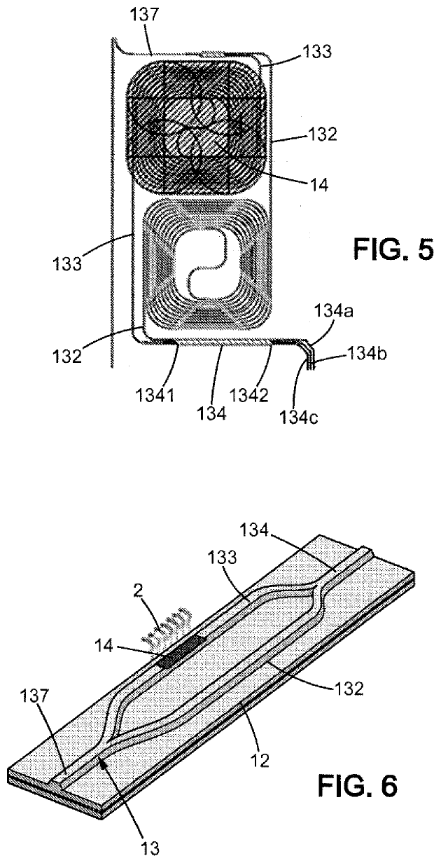

As visible in FIG. 4 representing an enlarged view of the zone referenced IV in FIG. 3 showing a part of light guide 13 situated near light inlet 135, and in FIG. 5 representing an enlarged view of the zone referenced V in FIG. 4, light guide 13 is divided into a plurality of branches 137, each branch 137 being divided into a reference arm 132 and a measurement arm 133, in which receptors 14 are arranged. Reference arm 132 and measurement arm 133 recombine into an interference arm 134.

FIG. 6 schematically represents a branch 137 of light guide 13, receptors 14 being arranged in measurement arm 133, and interacting with analyte 2.

In order to form branches 137, light guide 13 is successively divided, starting from light inlet 135. In particular, as visible in FIGS. 3 and 4, light guide 13 is divided into two first-row portions 13a, 13b of identical length constituting a first stage of light guide 13, and then each of these first-row portions 13a, 13b is in turn divided into two to form four second-row portions 13aa, 13ab, 13ba, 13bb of identical length, constituting a second stage of light guide 13. Each second-row portion 13aa, 13ab, 13ba, 13bb is in turn divided into two to form eight third-row portions of identical length constituting a third stage of light guide 13, and then each third-row portion is in turn divided into two to form sixteen fourth-row portions of identical length constituting a fourth stage of light guide 13, and then each fourth-row portion is in turn divided into two to form thirty-two fifth-row portions of identical length constituting a fifth stage of light guide 13, and then each fifth-row portion is in turn divided into two to form sixty-four sixth-row portions constituting a sixth stage of light guide 13. These sixty-four sixth-row portions each form one branch 137.

These successive divisions of the light guide make it possible to increase the number of branches 137 that will enable the presence of analyte 2 to be revealed. Light guide 13 may comprise more or fewer branches 137 than in the example illustrated. Thus, light guide 13 may comprise more or fewer stages than in the example illustrated. For example, light guide 13 may comprise five stages, the fifth stage thus comprising thirty-two fifth-row portions each forming a branch, or seven stages, the seventh stage thus comprising one hundred twenty-eight seventh-row portions each forming a branch.

As represented in FIG. 5, interference arm 134 of each branch 137 has a first end 1341 connected to reference arm 132 and to measurement arm 133, and a second end 1342. The light outlet 136 of light guide 13 is formed by second end 1342 of interference arm 134 of each branch 137.

In the example illustrated, interference arm 134 of each branch 137 is divided at its second end 1342 into a first sub-arm 134a, a second sub-arm 134b and a third sub-arm 134c. As illustrated in FIG. 3 and in FIG. 8 representing an enlarged view of the zone referenced VIII in FIG. 3, light outlet 136 of light guide 13 is thus formed by all three sub-arms 134a, 134b, 134c of each of branches 137.

Sensor 10 may also comprise a cap 15 integral with photonic chip 12. Cap 15 comprises an upper surface 15a arranged facing closing element 60. Cap 15 also comprises an intake opening 16a making it possible to admit the fluid to be analyzed into measurement chamber 11 and a discharge opening 16b making it possible to discharge the fluid from measurement chamber 11. The fluid may thus circulate from intake opening 16a to discharge opening 16b.

Intake opening 16a is positioned near a first end of measurement chamber 11 and discharge opening 16b is positioned near a second end of measurement chamber 11, thus guaranteeing the passage of fluid at receptors 14. In a variation not represented, cap 15 may comprise a single opening making it possible to both admit the fluid to be analyzed into measurement chamber 11 and to discharge the fluid from measurement chamber 11.

The closing element 60 comprises a connection 57a, 57b in fluid communication with the cap opening to enable the admission and discharge of fluid into and from the measurement chamber. Connection 57a, 57b of closing element 60 comprises a fluid intake conduit 57a in fluid communication with intake opening 16a of cap 15 and a fluid discharge conduit 57b in fluid communication with discharge opening 16b of cap 15. The fluid to be analyzed may thus be introduced into intake opening 16a by intake conduit 57a and may be discharged from discharge opening 16b by discharge conduit 57b.

Intake conduit 57a, respectively discharge conduit 57b, comprises a base 55 with a contact surface arranged facing intake opening 16a, respectively discharge opening 16b, which extends on both sides of intake opening, 16a respectively of discharge opening 16b, in order to guarantee leaktightness of measurement chamber 11. Bases 55 ensure good contact between intake conduit 57a and discharge conduit 57b on the one hand, and measurement chamber 11 on the other hand, in order to guarantee leaktightness between intake and discharge conduits 57a, 57b and cap 15 of sensor 10. In addition, bases 55 facilitate the alignment between intake conduit 57a and intake opening 16a on the one hand, and discharge conduit 57b and discharge opening 16b on the other hand.

Electronic analysis device 1 also comprises a transducer for the local property change caused by the interaction between temporary receptors 14 and analyte 2. This transducer makes it possible to convert the local property change into an electronic signal expressing the local property change.

The transducer comprises a coherent light source 130 and an optical detector 131. Light source 130 may be, for example, a laser diode. Light source 130 is aligned with light inlet 135 so that the light source 130 can emit a coherent light beam 129 into light guide 13 of photonic chip 12. The light beam 129 emitted by light source 130 has an emission axis A substantially perpendicular to the upper surface 15a of cap 15. The alignment between light source 130 and light inlet 135 of light guide 13 is thus facilitated.

Alternatively, emission axis A of light beam 129 may form a non-zero angle with an axis perpendicular to the upper surface 15a of cap 15. For example, the angle may be less than 5°, or even less than 1°.

Optical detector 131 is positioned facing light outlet 136 of light guide 13 and may measure an optical parameter of light beam 129 according to the local property change, at the outlet of light guide 13. For example, optical detector 131 may measure the light intensity of light beam 129 at the outlet of light guide 13, or the radiant power of light beam 129 at the outlet of light guide 13. Optical detector 131 is positioned on closing element 60.

In the first embodiment represented in FIGS. 1, 2 and 9, light source 130 is positioned on cap 15 of sensor 10. As sensor 10 is consumable, interchangeable, and reversibly placed in housing 51 of sensor support 50, sensor 10 may be easily replaced, without having to change the other parts of the device. Only the light source 130 that is positioned on cap 15 of sensor 10 is changed at the same time as sensor 10.

When sensor 10 is replaced by a new sensor, the new sensor also comprises a light source on the cap. The user carrying out the replacement then does not have to deal with the alignment between light source 130 and light inlet 135 of light guide 13 since the alignment will have been carried out by the manufacturer of the new sensor. The operation of electronic analysis device 1 is thus ensured following replacement of sensor 10.

In a first embodiment, light source 130 is arranged on electronic traces 128 etched on cap 15, which are visible in FIG. 10, and closing element 60 comprises an electronic circuit 127. An electric contactor 126 makes it possible to connect electronic traces 128 to electronic circuit 127 in order to supply power to light source 130. For example, electric connector 127 is a Pogo® pin.

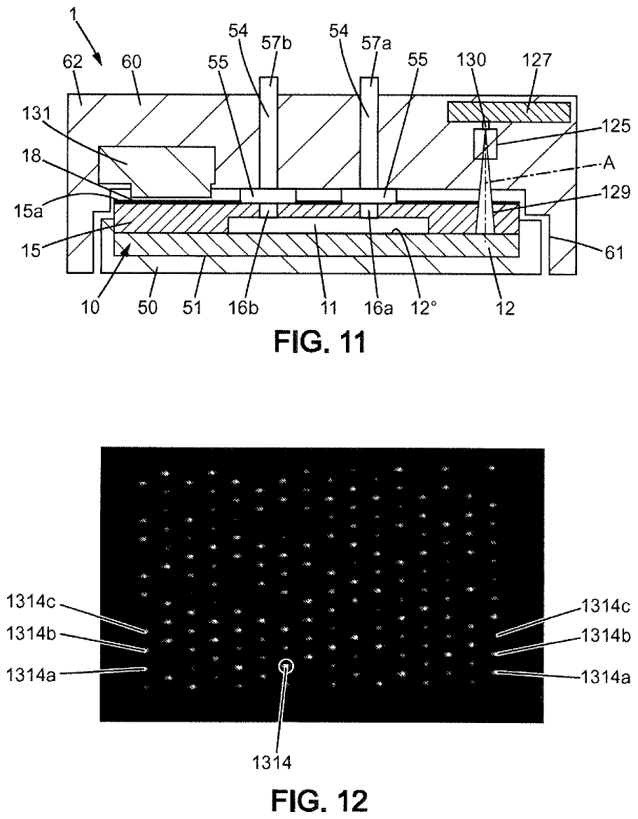

According to a second embodiment represented in FIG. 11, light source 130 is positioned on closing element 60. As sensor 10 is consumable, interchangeable, and reversibly placed in housing 51 of sensor support 50, sensor 10 may easily be replaced, without having to change the other parts of the device. Unlike the first embodiment, light source 130 may also be retained when sensor 10 is changed.

In addition, when sensor 10 is replaced by a new sensor, the alignment between light source 130 and light guide inlet 135 of the new sensor is ensured by the cooperation of sensor support 50 and closing element 60. In fact, the new sensor is positioned in housing 51 of sensor support 50, and closing element 60 is also indexed in relation to sensor support 50. Thus, thanks to the design of sensor support 50 and closing element 60, the alignment between light source 130 and light inlet 135 of light guide 13 is ensured. The alignment between light source 130 and light inlet 135 of light guide 13 is the responsibility of the manufacturer of the device, and not the user who carries out the replacement.

Optical system 125 is arranged facing light source 130 in order to collimate light beam 129 emitted by light source 130. For example, optical system 125 comprises at least one lens. In a variation, electronic analysis device 1 may lack an optical system, and light beam 129 emitted by light source 130 may be directly sent into light inlet 135 of light guide 13.

In this second embodiment, light source 130 is supplied with energy directly by electronic circuit 127 of closing element 60.

This second embodiment differs from the first embodiment only by the positioning of light source 130 in electronic analysis device 1 and the supply of energy to light source 130. Other features of electronic analysis device 1 are identical to those of the first embodiment.

In each of the first and second embodiments, to change sensor 10, sensor 10 is first removed from housing 51 of sensor support 50, and then the new sensor is positioned into housing 51 of sensor support 50.

In addition, in each of the first and second embodiments, closing element 60 comprises a peripheral wall 61 that reversibly fits together with sensor support 50, which enables easy access to sensor 10. In addition, this fit contributes to the proper alignment of closing element 60 with sensor support 50, and therefore, for the second embodiment, the proper alignment between light source 130 and light inlet 135 of light guide 13.

In addition, sensor 10 comprises protection for temporary receptors 14 which is configured to be active before the sensor is placed into housing 51 of sensor support 10 and to be deactivated by the placement of sensor 10 into housing 51 of sensor support 50.

This protection for temporary receptors 14 is visible in FIGS. 9 and 11, and includes a protective envelope 18 closing off intake opening 16a and discharge opening 16b of cap 15 before sensor 10 is placed into housing 51 of sensor support 50. When sensor 10 is placed into housing 51 of sensor support 50, protective envelope 18 cooperates with closing element 60, so as to be pierced facing intake opening 16a and discharge opening 16b of cap 15.

The rest of the description describes the propagation of light beam 129 emitted by light source 130 in electronic analysis device 1, and in particular in light guide 13. This propagation is identical for all embodiments that have been described.

Once light beam 129 is emitted by light source 130, light beam 129 enters light guide 13 via light inlet 135.

For example, the radiant power of light beam 129 at the inlet of the light guide is equal to or greater than 1 mW.

Light beam 129 is then guided into light guide 13. In particular, light beam 129 is divided at each stage of light guide 13 to propagate into each of the portions constituting the stage. The light beam thus propagates into each of the branches 137 of light guide 13.

In each branch 137 of light guide 13, part of the light beam is guided by total internal reflection in reference arm 132, and another part of the light beam is guided by total internal reflection in measurement arm 133. “Guided by total internal reflection” is understood to mean that when the light beam propagates into light guide 13, and meets the surface of light guide 13, no part of the light beam is refracted: the light beam is entirely reflected.

A resulting light beam, which results from recombining the part of the light beam guided into reference arm 132 and the other part of the light beam guided into measurement arm 133, is guided into interference arm 134.

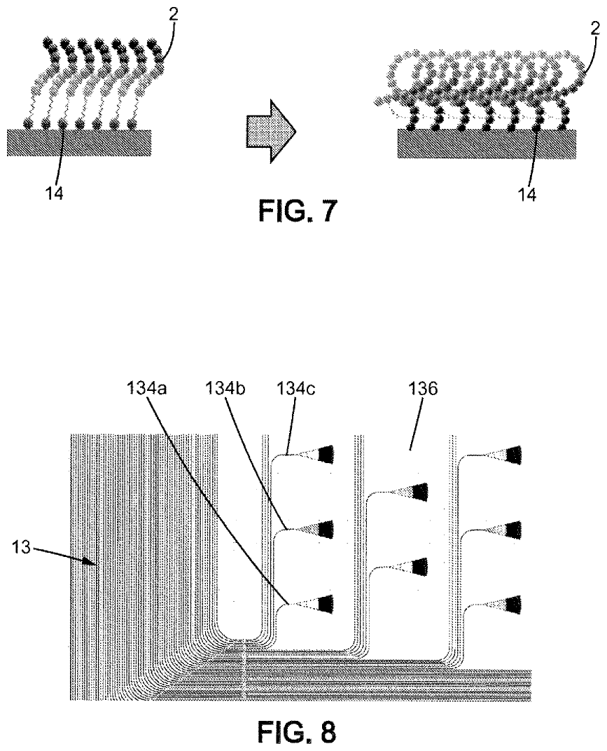

Each branch 137 of light guide 130 forms an interferometer making it possible to detect the presence of an analyte 2 in the fluid. In fact, when the fluid to be analyzed enters measurement chamber 11, temporary receptors 14 present in each of measurement arms 133 of branches 137 of light guide 13 will interact with analyte 2. As visible in FIG. 7, analyte 2 will, for example, bind to receptors 14. The interaction between receptors 14 and analyte 2 will then modify the optical index in measurement arm 133. This modification of the optical index in measurement arm 133 will generate a phase delay in the light beam guided into measurement arm 133 while the phase of the light beam guided into reference arm 132 is not modified.

When the light beam issued from measurement arm 133 and the light beam issued from reference arm 132 are recombined in interference arm 134, and form the resulting light beam, specific interferences from the phase delay taken by the light beam guided into measurement arm 133 are formed in the resulting light beam. These interferences are responsible for a specific light intensity distribution. This specific light intensity distribution is then detected by optical detector 131.

In general, in the device according to the invention, the resulting light beams are issued from interference arms 134 of the branches, these interference arms possibly being divided at least once into sub-arms, producing a matrix of specific light intensity distributions (points) (called “distributions” below), in the optical detector, each distribution preferably being represented by a light spot in grayscale. This distribution matrix is contained in an image, preferably rectangular, such as the one represented in FIG. 12, to illustrate a detection example that is described below.

In the example illustrated, the resulting light beam of each branch 137 is separated and guided into each of the three sub-arms 134a, 134b, 134c forming the second end of interference arm 134. Each of these three sub-arms shifts the phase of the resulting light beam, such that the phase shift between each sub-arm is equal to 120°. In other words, first sub-arm 134a receives a first part of the resulting light beam and shifts the phase of the first part of the resulting light beam by 0° in relation to the resulting light beam, i.e. the phase of the first sub-arm 134a is not shifted by the first part of the resulting light beam, the second sub-arm 134b receives a second part of the resulting light beam and shifts the phase of the second part of the resulting light beam by 120° in relation to the resulting light beam, and the third sub-arm 134c receives a third part of the resulting light beam and shifts the phase of the third part of the resulting light beam by 240° in relation to the resulting light beam.

Shifting the phase of the resulting light beam into three parts of the resulting light beam phase-shifted by 120° makes it possible for optical detector 131 to obtain more accuracy on the interferences formed in the resulting light beam. In particular, optical detector 131 can thus detect the sign of the phase shift of the light beam in measurement arm 133. Consequently, as this phase shift is due to the interaction between receptors 14 and analyte 2, obtaining the sign of the phase shift enables better detection of analyte 2.

The radiant power of the resulting light beam guided into interference arm 134 of each branch 137 is equal to or greater than 0.2 μW, which enables optical detector 131 to detect the specific intensity distribution generated in the resulting light beam of each branch 137.

The radiant power of the resulting light beam corresponds to the sum of the radiant powers at the outlet of each of sub-arms 134a, 134b, 134c of interference arm 134. In other words, the radiant power of the resulting light beam corresponds to the sum of the radiant powers from the first part of the resulting light beam, from the second part of the resulting light beam, and from the third part of the resulting light beam of the resulting light beam.

An example of the detection carried out by optical detector 131 is presented in FIG. 12. For each branch 137 of optical guide 13, and more specifically, for each sub-arm 134a, 134b, 134c of interference arm 134 of each branch 137, optical detector 131 receives a specific light intensity distribution. Each specific light intensity distribution is represented by a light spot 1314a, 1314b, 1314c in grayscale. For each branch 137, the specific light intensity distribution of first sub-arm 134a is represented by light spot 1314a, the specific light intensity distribution of second sub-arm 134b is represented by light spot 1314b, and the specific light intensity distribution of third sub-arm 134c is represented by light spot 1314c.

The radiant power of each resulting light beam corresponds to the radiant power of the three light spots 1314a, 1314b, 1314c, respectively representing the specific light intensity distribution of the first part of the resulting light beam, of the second part of the resulting light beam and of the third part of the resulting light beam of the resulting light beam.

The grayscale of each light spot 1314a, 1314b, 1314c may be between 0 and 255. The higher the grayscale, the brighter the light spot.

In order to optimize the detection carried out by optical detector 131, the detector preferably is calibrated during the first use of sensor 10.

Several methods of calibrating the optical detector are possible in the scope of the invention, particularly for all embodiments of the device according to the invention described in the present disclosure and in which each light intensity distribution, constituting the image in the optical detector, is represented by a light spot in grayscale. By way of example, described below are a 1^{st} calibration method with reference to the light spot having the highest grayscale, a 2^{nd} calibration method for taking account of the quality of the alignment between light source 130 and light inlet 135 of light guide 13 and a 3^{rd} calibration method for locating the light intensity distributions (points) emitted by light guide 13.

1^{st} Method of Calibrating the Optical Detector with Reference to the Light Spot Having the Highest Grayscale

This calibration is advantageously done before the first detection, but preferably may then be used for all sensor acquisitions. The calibration may also be recalled at any time by the automated system or by the user, to adjust the output values.

It is preferable that the sensor is not saturated, but it can still detect specific light intensity distributions. Thus, at least during the first detection of optical detector 131, light spot 1314 having the highest grayscale is taken as the reference, and the exposure time of optical detector 131, i.e. the duration during which optical detector 131 measures the specific light intensity distributions, is modified such that each referent light spot 1314 has a predetermined grayscale or is included within a predetermined grayscale range.

In other words, this 1^{st} calibration method, advantageously implemented by computer, at least during the first detection, essentially consists of:
(i.1) identifying the light spot having the highest grayscale, in the matrix of distributions (points) made of light spots in grayscale, contained in an image that is formed in the optical detector;
(ii.1) taking this light spot as a reference;
(iii.1) adjusting the exposure time of the optical detector, i.e. the duration during which the optical detector measures the specific light intensity distributions, such that the referent light spot has a grayscale Ng at least equal to a predetermined grayscale Ng°, or included within a grayscale range [Ng¹_-Ng²].

Another object of the present invention is an electronic device for analyzing an analyte present in a fluid, said device being equipped with means enabling this 1^{st} calibration method to be carried out during the analysis.

For example, if the grayscale of the referent light spot 1314 is less than the predetermined grayscale Ng° or than the lowest value Ng¹ of the predetermined grayscale range [Ng¹-Ng²], the exposure time of optical detector 131 will be increased so that optical detector 131 can receive more light over the duration of the measurement. On the other hand, if the grayscale of the referent light spot 1314 is greater than the predetermined grayscale Ng° or than the highest value Ng² of the predetermined grayscale range [Ng¹-Ng²], the exposure time of optical detector 131 will be reduced so that optical detector 131 can receive less light over the duration of the measurement.

However, it is preferable that the exposure time of optical detector 131 does not exceed a maximum exposure time, such as for example 1000 μs. In fact, beyond the maximum exposure time, the time for carrying out the measurement is too long to have sufficient detection accuracy.

The closer the radiant power of a resulting light beam moves towards 0.2 μW, while remaining above 0.2 μW, the longer the exposure time, so that optical detector 131 can correctly detect the specific light intensity distribution of the resulting light beam.

If the radiant power of the resulting light beam is less than 0.2 μW, then it becomes difficult to calibrate optical detector 131 properly to enable good detection of the specific light intensity distribution of the resulting light beam. In fact, the exposure time enabling optical sensor 131 to capture the resulting light beam then becomes greater than the maximum exposure time, in particular, the exposure time becomes greater than 1000 μs.

According to one noteworthy possibility of the invention, grayscales Ng°, Ng¹ & Ng² are encoded in 8 bits, and therefore have a value that can vary from 0 to 255. For example, Ng°=150; Ng¹=140; Ng²=160.

With reference to this “18 calibration method of the optical detector with reference to the light spot having the highest grayscale,” another object of the invention relates to a 1^{st} embodiment, advantageously implemented by computer, of a method of analyzing an analyte present in a fluid by means of the device according to the invention. This 1^{st} embodiment is characterized in that it comprises the 1^{st} method of calibrating the optical detector.

This 1^{st} embodiment, implemented by computer, of the analysis method can be implemented by a system comprising the device according to the invention and a central processing unit of the device, preferably forming an integral part of the device (“firmware”).

### 2^{nd} Calibration Method for Taking Account of the Quality of the Alignment Between Light Source 130 and Light Inlet 135 of Light Guide 13

The useful radiant power, incident on the surface of the optical detector, depends in particular on the quality of the alignment of the light source with the inlet of the light guide. The 2^{nd} calibration method according to the invention is a calibration of the exposure time of optical detector 131, in order to, where appropriate, correct the measurement of the resulting light beam, according to the alignment/misalignment between the light source and the inlet of the light guide, particularly following a replacement of the sensor in the device according to the invention.

This calibration is advantageously done before the first detection, but preferably may then be used for all sensor acquisitions. The calibration may also be recalled at any time by the automated system or by the user, to adjust the output values.

In other words, this 2^{nd} calibration method, advantageously implemented by computer, at least during the first detection, essentially consists of:
(i.2) identifying the light spot having the highest grayscale, in the matrix of distributions (points) made of light spots in grayscale, contained in an image that is formed in the optical detector;
(ii.2) taking this light spot as a reference;
(iii.2) adjusting the exposure time of the optical detector, i.e. the duration during which the optical detector measures the specific light intensity distributions, such that the referent light spot has a grayscale Ng at least equal to a predetermined grayscale Ng^{max}, corresponding to the upper limit of a grayscale range [Ng¹⁰; Ng²⁰];
(iv.2) and, when Ng=Ng^{max}, repeating the same detection, i.e. the same measurement, several times to obtain several matrices of light intensity distributions (points), contained in (x) images;
(v.2) measuring Ng in each of these (x) images;
(vi.2) if Ng=Ng^{max}=Ng^{x}, in all or part of these (x) images, preferably in all of these (x) images, then the corresponding exposure time is saved for the following measurements. Thus another object of the present invention is an electronic device for analyzing an analyte present in a fluid, said device being equipped with means enabling this 2^{nd} calibration method to be carried out during the analysis.

This 2^{nd} calibration method makes it possible, particularly through its step (iv.2), to smooth out any possible variations due to noise on several images.

Advantageously, (x) is between 1 and 30, preferably between 2 and 20.

Advantageously, the exposure time is between 25 and 10,000 μs, preferably between 500 and 5,000 μs.

Advantageously, [Ng¹⁰; Ng²⁰] is defined as follows [16; 150].

With reference to this 2^{nd} calibration method, in order to take into consideration the quality of the alignment between light source 130 and light inlet 135 of light guide 13″, another object of the invention relates to a 2^{nd} embodiment, advantageously implemented by computer, of a method for analyzing an analyte present in a fluid by means of the device according to the invention. This 2^{nd} embodiment is characterized in that it comprises the 2^{nd} calibration method of the optical detector.

This 2^{nd} embodiment, implemented by computer, of the analysis method can be implemented by a system comprising the device according to the invention and a central processing unit of the device, preferably forming an integral part of the device (“firmware”).

### 3^{rd} Calibration Method for Locating the Light Intensity Distributions (Points) Emitted by Light Guide 13

Enhancing the performance of the device according to the invention involves locating the light intensity distributions (points) emitted by light guide 13, in a matrix of specific light intensity distributions (points) contained in an image forming in the optical detector. Locating these distributions enables the system to construct the measured analytical signals (e.g. odors) correctly, from reliable information that reflects the measured analytes.

This calibration is advantageously done before the first detection, but preferably may then be used for all sensor acquisitions. The calibration may also be recalled at any time by the automated system or by the user, to adjust the output values.

This 3^{rd} calibration method, advantageously implemented by computer, at least during the first detection, essentially consists of:
(i.3) identifying and locating each light spot constituting the matrix of distributions (points) of the image that forms in the optical detector, preferably in an image with a rectangular shape, by means of the center of the light spot, in a coordinate system XY of which the origin is a given point in the image, preferably one of the corners of the image when the image is rectangular, the matrix thus being composed of Xⁿ rows of Y^{m} light spots;
(ii.3) identifying the most luminous light spot T^{l} of the image, in a row X^{n=b*};
(iii.3) tracing a scan line passing through the center of this most luminous spot while also being parallel to the Y axis;
(iv.3) carrying out, at this scan line, angular scanning by rotation around the center of the most luminous spot, according to an +alpha/−alpha angle, forming an angular sector comprising a line parallel to the Y axis;
(v.3) obtaining the angle of rotation (alpha C) in which the scan line intersects Y^{m-1} light spots of row X^{n=b*};
(vi.3) for each of Xⁿ⁻¹ rows of Y^{m} light spots,
****(vi.3.1) identifying the most luminous light spot of the row, in each row X^{n·b*},
****(vi.3.2) tracing a scan line passing through the center of this most luminous spot while also being parallel to the Y axis,
****(vi.3.3) carrying out, at this scan line, angular scanning by rotation around the center of the most luminous spot, according to the angle (alpha C), in order to find the line intersecting Yⁿ⁻¹ light spots of row X^{n≠b*}, and more specifically to find these Y^{m-1} light spots of row X^{n≠b*};
(vii.3) obtaining the coordinates (X,Y) of [Xⁿ×Y^{m}] light spots constituting the matrix that is contained in the image forming in the optical detector;
(viii.3) storing these coordinates in memory;
(ix.3) and using these coordinates to read the resulting light beams in the context of the method according to the invention of analyzing an analyte present in a fluid, by means of the device according to the invention.

Thus another object of the present invention is an electronic device for analyzing an analyte present in a fluid, said device being equipped with means enabling this 3^{rd} calibration method to be carried out during the analysis.

Advantageously, the |alpha| angle (in degrees) is between 1 and 10, preferably between 2 and 8, and more preferably between 3 and 7.

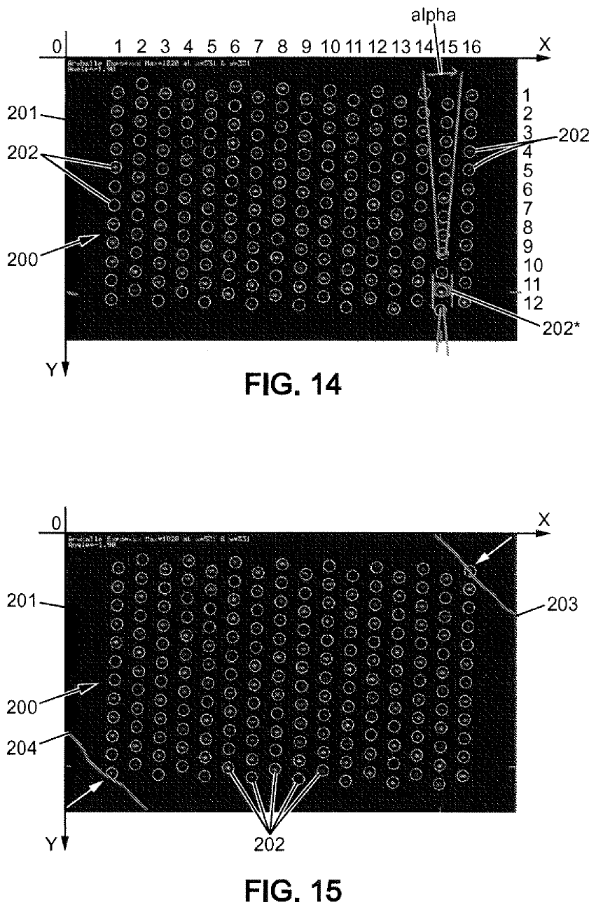

The attached FIG. 14 illustrates this 3^{rd} calibration method. In this figure, one can see matrix 200 included in rectangular image 201. Matrix 200 is formed by light spots 202. The most luminous light spot is denoted 202*. FIG. 14 also shows the alpha scanning angle.

In an advantageous variation of this 3^{rd} calibration method, where the image has a rectangular shape and comprises a frame defining its periphery, an additional procedure is provided, comprising the following essential steps:
(i^{c}.3) the image is scanned along a direction forming a beta angle with the X or Y axis, starting from at least one of the corners of the frame of this image, preferably at least the 2 diagonally opposite corners of the image, and still more preferentially the lower right corner and the lower left corner of each image;
(ii^{c}.3) once a radiant power/value equal to or greater than P^{c} is detected during scanning, said power/value is attributed to the corresponding light spot at the corner of the image and the relevant light spot is identified accordingly.

Advantageously, the |beta| angle (in degrees) is between 30 and 80, preferably between 40 and 50, and still more preferentially on the order of 45.

The attached FIG. 15 illustrates this variant of the 3^{rd} calibration method. In this figure, one can see matrix 200 included in rectangular image 201. Matrix image 200 is formed by light spots 202. Scan lines 203 & 204, which respectively originate from the upper right corner and the lower left corner of image 201, form a 45° angle with the X axis and the Y axis.

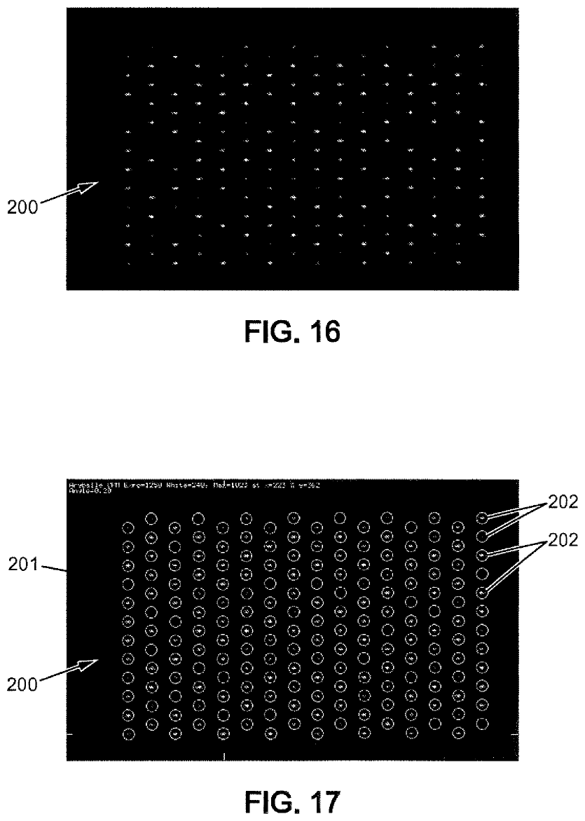

FIGS. 16 and 17 respectively show, first, an uncalibrated matrix/image 200 and, second, a matrix 200 calibrated according to the 1^{st}, 2^{nd} & 3^{rd} methods according to the invention described above.

With reference to this 3^{rd} calibration method for locating the light intensity distributions (points) emitted by light guide 13, another object of the invention relates to a 3^{rd} embodiment, advantageously implemented by computer, of a method of analyzing an analyte present in a fluid by means of the device according to the invention, such as described in the present disclosure. This 3^{rd} embodiment is characterized in that it comprises the 3^{rd} method of calibrating the optical detector.

This 3^{rd} embodiment, implemented by computer, of the analysis method can be implemented by a system comprising the device according to the invention and a central processing unit of the device, preferably forming an integral part of the device (“firmware”).

During detection, analyte 2 is introduced into measurement chamber 11 by intake opening 16a, and is then discharged from measurement chamber 11 by discharge opening 16b. Thus, analyte 2 circulates in measurement chamber 11. The interaction between receptors 14 and analyte 2 thus changes over time. The interferences formed in the resulting light beam of each branch 137 also change over time, which means that the specific light intensity distribution of the resulting light beam of each branch 137 changes over time. Therefore, the grayscale of each light spot 1314a, 1314b, 1314c varies over time.

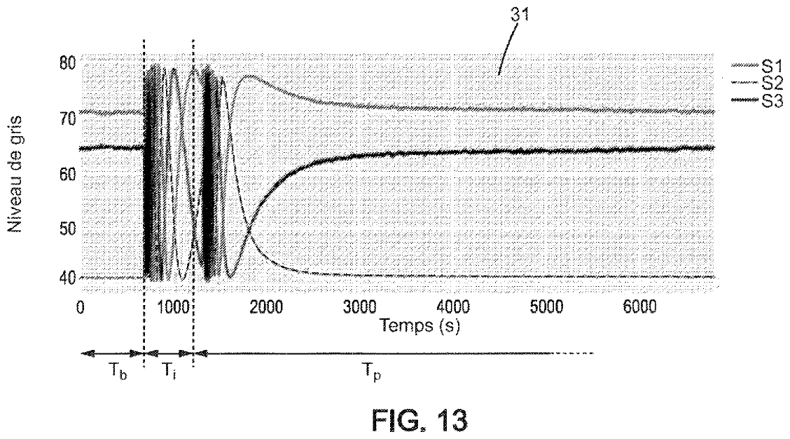

For each resulting light beam, and thus for the first, second, and third parts of each resulting light beam, this variation in grayscale is transformed into an electronic signal by optical detector 131. All of the electronic signals generated thus form a multidimensional electronic signal 31. An example of a multidimensional electronic signal 31 generated by optical detector 131 is presented in FIG. 13.

The electronic signals express the phase delay of the light beam guided in measurement arm 133 compared to the light beam guided in reference arm 132 for each branch 137, and thus express the optical index change in measurement arm 133, i.e. the interaction between analyte 2 and temporary receptors 14. Thus, thanks to light source 130, optical guide 13 and optical detector 131, it is possible to detect the optical index change generated by the interaction between analyte 2 and receptors 14, and thus to detect the presence of analyte 2 in the analyzed fluid.

FIG. 13 represents electronic signals S1, S2, S3 corresponding to a resulting light beam. Thus three curves are observed that respectively represent the variation in grayscale of light spot 1314a of the first part of the resulting light beam over time, the variation in grayscale of light spot 1314b of the second part of the resulting light beam over time, and the variation in grayscale of light spot 1314c of the third part of the resulting light beam over time.

During time period Tb, a known reference fluid is introduced into measurement chamber 11. Multidimensional electronic signal 31 presents a reference value. During time period Ti, the fluid to be analyzed is introduced into measurement chamber 11. A modification in multidimensional electrical signal 31 is then observed. This modification is characteristic of the interaction between analyte 2 and receptors 14. During period Tp, the reference fluid is again introduced into the measurement chamber. Multidimensional electronic signal 31 is then modified until it returns to its reference value. This time period Tp makes it possible to purge measurement chamber 11 and enables analyte 2, having interacted with receptors 14, to also exit measurement chamber 11. At the end of period Tp, measurement chamber 11 is then ready to receive a new fluid to be analyzed and receptors 14 are then ready to receive analyte 2 of the new fluid to be analyzed.

However, it may occur that some of analyte 2 of the analyzed fluid remains on temporary receptors 14. The multidimensional electronic signal then does not return to its exact reference value, but to a value close to this reference value. If this value is too far from the reference value, then temporary receptors 14 must be changed. Sensor 10 must be replaced.

For example, temporary receptors 14 may be tested before any usage, in ambient air. Then an initial reference value for multidimensional electronic signal 31 is obtained. If during period Tp, the value of multidimensional electronic signal 31 takes a value with a deviation of less than 10% compared to the initial reference value, then temporary receptors 14 can be maintained and sensor 10 can be kept.

On the other hand, if during time period Tp, the value of multidimensional electronic signal 31 takes a value with a deviation of more than 10% compared to the initial reference value, then temporary receptors 14 must be changed and sensor 10 or electronic analysis device 1 must be replaced.

In the first and second embodiments, described above and shown in FIGS. 9 & 11, of the device according to the invention, photonic chip 12 presents, at its functionally active upper surface facing measurement chamber 11, light guide 13 and receptors 14 intended to react with analytes 2. Cap 15 defining measurement chamber 11 as well as closing element 60 traversed by intake conduit 57a and discharge conduit 57b are arranged above photonic chip 12 and, in particular, above its active upper surface.

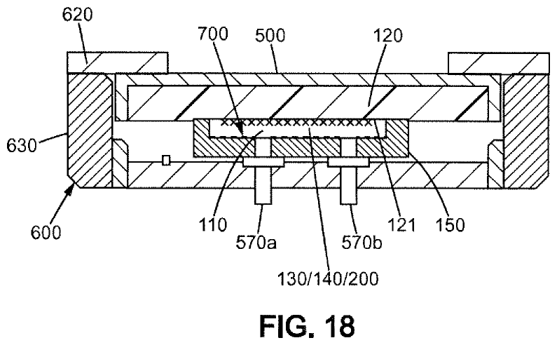

According to a variation embodiment of the device according to the invention shown in FIG. 18, cap 150 defining measurement chamber 110 is arranged below photonic chip 120 and, in particular, below its functionally active lower surface 121 which faces measurement chamber 110.

Advantageously, closing element 600 may also be arranged below photonic chip 120 and, in particular, below its functionally active lower surface 121.

Surface 121 comprises light guide 130 and receptors 140 intended to react with analytes 200 (not visible in FIG. 18).

Closing element 600 is constituted of a lower piece 630 traversed by intake conduit 570a and discharge conduit 570b and an upper piece 620. Lower 630 and upper 620 pieces are connected to each other by hinge 640, not represented in FIG. 18.

This variation embodiment of the device according to the invention offers the advantage that possible soiling 700 present in measurement chamber 110 rests, due to gravity, on the bottom of measurement chamber 110. This bottom is formed by the base of cap 150.

This advantageous form limits the risks of pollution, which is particularly positive for the reliability of measurements and for increasing the lifetime of the photonic chip.

The numerical references of this FIG. 18 designate elements equivalent to the elements of the first two embodiments of the device, identified by the same numerical references multiplied by 10.

1. An electronic device (1) for analyzing an analyte (2) present in a fluid, characterized in that it comprises:
a consumable and interchangeable sensor (10) comprising
i) a photonic chip (12) comprising at least one measurement chamber (11) comprising a light guide (13) in which temporary receptors (14) capable of interacting with the analyte present in the fluid are arranged, the interaction causing a local property change, the light guide (13) comprising a light inlet (135) and a light outlet (136), and
ii) a cap (15) integral with the photonic chip and comprising an opening (16a, 16b) suitable for admitting fluid into the measurement chamber and for discharging fluid from the measurement chamber;
a sensor support (50) comprising a housing (51) in which the sensor is intended to be placed in a reversible manner;
a closing element (60) cooperating with the sensor support to encapsulate the sensor;
a local property change transducer, the change being caused by the interaction between the receptors and the analyte, capable of converting the local property change into an electronic signal expressing the local property change, this transducer comprising:
a coherent light source (130), on the one hand, capable of emitting a coherent light beam (129) into the light guide of the photonic chip, and, on the other hand, positioned on the cap of the sensor or on the closing element;
an optical detector (131) arranged facing the light outlet of the light guide and capable of measuring an optical parameter of the light beam according to the local property change, at the outlet of the light guide.

2. The device according to claim 1, wherein the light guide (13) comprises at least one branch (137) comprising a reference arm (132) in which a part of the light beam emitted by the light source is intended to be guided by total internal reflection, and a measurement arm (133) in which another part of the light beam emitted by the light source is intended to be guided by total internal reflection and in which the receptors (14) are arranged, the reference arm (132) and the measurement arm (133) being recombined into an interference arm (134) into which a resulting light beam which results from recombining the part of the light beam guided into the reference arm and the other part of the light beam guided into the measurement arm is intended to be guided, and
wherein the radiant power of the resulting light beam guided into the interference arm (134) is equal to or greater than 0.2 μW.

3. The device according to claim 2, wherein the resulting light beams are issued from interference arms of the branches, these interference arms possibly being divided at least once into sub-arms, producing a matrix of specific light intensity distributions (points) (called “distributions” below), in the optical detector, each distribution preferably being represented by a light spot in grayscale.

4. The device according to claim 1, wherein the light source is positioned on the cap of the sensor and comprising
electronic traces (128) etched on the cap on which the light source is arranged,
an electronic circuit (127) on the closing element, and
an electric contactor (126) enabling the electronic traces to be connected to the electronic circuit in order to supply power to the light source.

5. The device according to claim 1, wherein the light source is positioned on the closing element, and comprising an optical system that preferably comprises at least one lens, which is intended to collimate the light beam.

6. The device according to claim 1, wherein the sensor comprises protection for the temporary receptors which is configured to be active before the sensor is placed into the housing of the sensor support and to be deactivated by the placement of the sensor into the housing of the sensor support.

7. The device according to claim 1, wherein the cap 150 defining the measurement chamber 110 is arranged below the photonic chip 120 and, in particular, below its functionally active lower surface 121, which faces the measurement chamber 110.

8. The device according to claim 3, equipped with means enabling a 1^{st} calibration method to be carried out, advantageously implemented by computer, at least during the first detection, this 1^{st} method essentially consisting of:
(i.1) identifying the light spot having the highest grayscale, on the matrix of distributions (points) made of light spots in grayscale, contained in an image that is formed in the optical detector;
(ii.1) taking this light spot as a reference;
(iii.1) adjusting the exposure time of the optical detector, i.e. the duration during which the optical detector measures the specific light intensity distributions, such that the referent light spot has a grayscale Ng at least equal to a predetermined grayscale Ng°, or included within a grayscale range [Ng¹-Ng²].

9. The device according to claim 3 equipped with means enabling a 2^{nd} calibration method to be carried out, advantageously implemented by computer, at least during the first detection, this 2^{nd} method essentially consisting of:
(i.2) identifying the light spot having the highest grayscale, in the matrix of distributions (points) made of light spots in grayscale, contained in an image that is formed in the optical detector;
(ii.2) taking this light spot as a reference;
(iii.2) adjusting the exposure time of the optical detector, i.e. the duration during which the optical detector measures the specific light intensity distributions, such that the referent light spot has a grayscale Ng at least equal to a predetermined grayscale Ng^{max}, corresponding to the upper limit of a grayscale range [Ng¹⁰-Ng²⁰];
(iv.2) and, when Ng=Ng^{max}, repeating the same detection, i.e. the same measurement, several times to obtain several matrices of light intensity distributions (points), contained in (x) images;
(v.2) measuring Ng in each of these (x) images;
(vi.2) if Ng=Ng^{max}=Ng^{x}, in these (x) images, then the corresponding exposure time is saved for the following measurements.

10. The device according to claim 3 equipped with means enabling a 3^{rd} calibration method to be carried out, advantageously implemented by computer, at least during the first detection, this 3^{rd} method essentially consisting of:
(i.3) identifying and locating each light spot constituting the matrix contained in an image, preferably rectangular, forming in the optical detector, by means of the center of the light spot, in a coordinate system XY of which the origin is a given point in the image, preferably one of the corners of the image when the image is rectangular, the matrix thus being composed of Xⁿ rows of Y^{m} light spots;
(ii.3) identifying the most luminous light spot T′ of the image, in a row X^{n=b*};
(iii.3) tracing a scan line passing through the center of this most luminous spot while also being parallel to the Y axis in an image having a rectangular shape;
(iv.3) carrying out, at this scan line, angular scanning by rotation around the center of the most luminous spot, according to an +alpha/−alpha angle, forming an angular sector comprising a line parallel to the Y axis;
(v.3) obtaining the angle of rotation (alpha C) in which the scan line intersects Y^{m-1} light spots of row X^{n=b*};
(vi.3) for each of Xⁿ⁻¹ lines of Y^{m} light spots,
(vi.3.1) identifying the most luminous light spot of the row, in each row X^{n≠b*},
(vi.3.2) tracing a scan line passing through the center of this most luminous spot while also being parallel to the Y axis in an image having a rectangular shape,
(vi.3.3) carrying out, at this scan line, angular scanning by rotation around the center of the most luminous spot, according to the angle (alpha C), in order to find the line intersecting Y^{m-1} light spots of row X^{n≠b*}, and more specifically to find these Y^{m-1} light spots of row X^{n·b*};
(vii.3) obtaining the coordinates (X,Y) of [Xⁿ×Y^{m}] light spots constituting the matrix, and that are contained in the image forming in the optical detector;
(viii.3) storing these coordinates in memory;
(ix.3) and using these coordinates to read the resulting light beams in the context of the method according to the invention of analyzing an analyte present in a fluid, by means of the device according to the invention.

11. A method of analyzing an analyte present in a fluid by means of the device according to claim 1, characterized in that the method comprises, in a first embodiment, advantageously implemented by computer, the 1^{st} calibration method for the optical detector comprising:
(i.1) identifying the light spot having the highest grayscale, on the matrix of distributions (points) made of light spots in grayscale, contained in an image that is formed in the optical detector;
(ii.1) taking this light spot as a reference;
(iii.1) adjusting the exposure time of the optical detector, i.e. the duration during which the optical detector measures the specific light intensity distributions, such that the referent light spot has a grayscale Ng at least equal to a predetermined grayscale Ng° or included within a grayscale range [Ng¹-Ng²].

12. A method of analyzing an analyte present in a fluid by means of the device according to claim 1, characterized in that the method comprises, in a second embodiment, advantageously implemented by computer, the 2^{nd} calibration method for the optical detector comprising:
(i.2) identifying the light spot having the highest grayscale, in the matrix of distributions (points) made of light spots in grayscale, contained in an image that is formed in the optical detector;
(ii.2) taking this light spot as a reference;
(iii.2) adjusting the exposure time of the optical detector, i.e. the duration during which the optical detector measures the specific light intensity distributions, such that the referent light spot has a grayscale No at least equal to a predetermined grayscale Ng^{max} corresponding to the upper limit of a grayscale range [Ng¹⁰-Ng²⁰];
(iv.2) and, when Ng=Ng^{max}, repeating the same detection, i.e. the same measurement, several times to obtain several matrices of light intensity distributions (points), contained in (x) images;
(v.2) measuring Ng in each of these (x) images;
(vi.2) if Ng=Ng^{max}=Ng^{x}, in these (x) images, then the corresponding exposure time is saved for the following measurements (i.2) identifying the light spot having the highest grayscale, in the matrix of distributions (points) made of light spots in grayscale, contained in an image that is formed in the optical detector;
(ii.2) taking this light spot as a reference;
(iii.2) adjusting the exposure time of the optical detector, i.e. the duration during which the optical detector measures the specific light intensity distributions, such that the referent light spot has a grayscale Ng at least equal to a predetermined grayscale Ng^{max}, corresponding to the upper limit of a grayscale range [Ng¹⁰-Ng²⁰];
(iv.2) and, when Ng=Ng^{max} repeating the same detection, i.e. the same measurement, several times to obtain several matrices of light intensity distributions (points), contained in (x) images:
(v.2) measuring Ng in each of these (x) images;
(vi.2) if Ng=Ng^{max}=Ng^{x} in these (x) images, then the corresponding exposure time is saved for the following measurements.

13. A method of analyzing an analyte present in a fluid by means of the device according to claim 1, characterized in that the method comprises, in a third embodiment, advantageously implemented by computer, the 3^{rd} calibration method for the optical detector comprising:
(i.3) identifying and locating each light spot constituting the matrix contained in an image, preferably rectangular, forming in the optical detector, by means of the center of the light spot, in a coordinate system XY of which the origin is a given point in the image, preferably one of the corners of the image when the image is rectangular, the matrix thus being composed of Xⁿ rows of Y^{m} light spots;
(ii.3) identifying the most luminous light spot T^{l} of the image, in a row X^{n=b*};
(iii.3) tracing a scan line passing through the center of this most luminous spot while also being parallel to the Y axis in an image having a rectangular shape;
(iv.3) carrying out, at this scan line, angular scanning by rotation around the center of the most luminous spot, according to an +alpha/−alpha angle, forming an angular sector comprising a line parallel to the Y axis;
(v.3) obtaining the angle of rotation (alpha C) in which the scan line intersects Y^{m-1} light spots of row X^{n=b*};
(vi.3) for each of Xⁿ⁻¹ lines of Y m light spots,
(vi.3.1) identifying the most luminous light spot of the row, in each row X^{n≠b*},
(vi.3.2) tracing a scan line passing through the center of this most luminous spot while also being parallel to the Y axis in an image having a rectangular shape,
(vi.3.3) carrying out, at this scan line, angular scanning by rotation around the center of the most luminous spot, according to the angle (alpha C), in order to find the line intersecting Y^{m-1} light spots of row X^{n≠b*}, and more specifically to find these Y^{m-1} light spots of row X^{n≠b*};
(vii.3) obtaining the coordinates (X,Y) of [Xⁿ×Y^{m}] light spots constituting the matrix, and that are contained in the image forming in the optical detector;
(viii.3) storing these coordinates in memory;
(ix.3) and using these coordinates to read the resulting light beams in the context of the method according to the invention of analyzing an analyte present in a fluid, by means of the device according to the invention.

14. A method of replacing a sensor (10) of an electronic analysis device (1) according to claim 1, wherein
the sensor is removed from the housing of the sensor support,
a new sensor is positioned in the housing of the sensor support.
